(19) United States
(12) Patent Application Publication
(10) Pub. No.: US 2003/0187913 A1
(43) Pub. Date: Oct. 2, 2003

(54) Flexible distribution of service-related data

(76) Inventor: Sam L. Falkner, Louisville, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/108,139

(22) Filed: Mar. 26, 2002

(51) Int. Cl. G06F 15/16

(52) U.S. Cl. 709/201

(57) ABSTRACT

A computer-based system and method for distributing data files received from a remote computer to selected participants in a service network is disclosed. Participants in the service network may request that selected data files be distributed to particular nodes in the service network. These requests may be stored in a suitable memory location in the service network nodes. When a network node receives a data file, the data file may be distributed to one or more second-tier network nodes whose requests have been stored in memory of the receiving node. The second-tier network nodes may, in turn, distribute the data file to one or more third-tier network nodes. The system includes safeguards to prevent infinite loops of cross-traffic.

### BACKGROUND OF THE INVENTION

1. Field of the Invention

The present invention relates to computer-based information systems, and more particularly to a system and method for distributing data files received from a remote computer to selected participants in a service network.

2. Background of the Invention

In modern enterprise digital data processing systems, that is, computer systems for use in an office environment in a company, a number of personal computers, workstations, and other devices such as mass storage subsystems, network printers and interfaces to the public telephony system, are typically interconnected in a computer network. The personal computers and workstations (generally, “computers”) may be used to perform processing in connection with data and programs that may be stored in the network mass storage subsystems.

In such an arrangement, the computers, operating as clients, access the data and programs from the network mass storage subsystems for processing. In addition, the computers may enable processed data to be uploaded to the network mass storage subsystems for storage, to a network printer for printing, to the telephony interface for transmission over the public telephony system, or the like. In such an arrangement, the network mass storage subsystems, network printers and telephony interface operate as servers, since they are available to service requests from multiple clients in the network. By organizing the network in such a manner, the servers are readily available for use by multiple computers in the network.

Such enterprise computer systems may include multiple computing centers spread over a wide geographic region. For example, an enterprise system may include host computers (e.g., servers, minicomputers, or mainframes) located in data centers in the United States, Europe, South America and Asia. The host computers may be connected by an appropriate communication connection, e.g., an ATM connection over a fiber optic cable.

Computer system components such as servers are relatively expensive and are subject to high availability requirements. Accordingly, operators of computer systems may choose to purchase a service contract to support such computer systems. Computer support service providers may install software on computers to collect information about a computer and to enhance their productivity and ability to service computers from a remote location. The information may include, e.g., information about the status, configuration, and identification of various hardware or software components, or any other information that may be useful in diagnosing and/or servicing problems with the computer.

For example, Sun Microsystems offers a variety of support services plans. In connection with these service plans, Sun implements a software tool (referred to herein as the “Explorer”) that collects information from a computer running the Solaris™ operating environment. Service personnel may then use this information as an aid in servicing a computer.

Remote monitoring software, such as the Sun™ Explorer Data Collector software tool can automatically send data collected from a remote computer across a communication medium to a service support center. Such service support centers may receive input from hundreds, or possibly thousands, of remote computers. To expedite data processing, it is desirable to have the data recognized and converted to a canonical format automatically.

For a variety of reasons, including human intervention, data transmitted from a remote computer to the service center may arrive in a variety of different formats. For example, the data may arrive in tar format, or in compression formats such as gzip and bzip2, or in a binary-to-ASCII conversion protocol such as uuencode or base64. Accordingly, there is a need in the art for a system and method for automatically recognizing data files received at a computer support service center that can accommodate a wide variation in data formats.

After data files from remote computers have been received and authenticated at a service center, the data files may need to be evaluated by technical experts to diagnose the errors. It will be appreciated that technical experts may be scattered across the globe. Accordingly, there is also a need in the art for systems and methods for distributing this data to desired technical experts who may be geographically dispersed.

### SUMMARY OF THE INVENTION

In one aspect, the present invention addresses these and other needs by providing systems and methods for distributing data files received from one or more remote computers to selected participants in a service network. Remote computers transmit data files to a network service center. Participants in the service network may request that selected data files be distributed to particular nodes in the service network. When a network node receives a data file, the data file may be distributed to one or more second-tier network nodes identified as target nodes in a memory of the receiving node. The second-tier network nodes may, in turn, distribute the data file to one or more third-tier network nodes identified as target nodes in a memory of the second tier nodes.

In one embodiment, the invention provides a method for distributing a data file received at a service center to selected nodes of a service network. The method comprises the steps of receiving a data file at a receiving node of a service network; determining whether the data file is to be distributed to one or more target nodes in the service network; determining whether the data file matches criteria for one or more target nodes, and if so then retrieving an identifier associated with the one or more target nodes for which there is a criteria match; and determining whether the identifier associated with the one or more target nodes is in a PATH file associated with the data file, and if not then sharing the data file with the one or more target nodes.

In another embodiment, the invention provides a service network comprising a plurality of service nodes, at least one of which is a receiving node for receiving data files from computers being monitored by the service network. The service network further comprises a processor associated with the receiving node for determining whether a received data file is to be distributed to one or more target nodes in the service network, determining whether the data file matches criteria for one or more target nodes, and if so then retrieving an identifier associated with the one or more target nodes for which there is a criteria match, and determining whether the identifier associated with the one or more target nodes is in a PATH file associated with the data file, and if not then sharing the data file with the one or more target nodes.

In yet another embodiment, the invention provides a computer program product for use in connection with a computer for processing data files received at a receiving node of a service network and distributing data files to selected nodes of a service network. The computer program product comprises logic instructions for receiving a data file at a receiving node of a service network; logic instructions for determining whether the data file is to be distributed to one or more target nodes in the service network; logic instructions for determining whether the data file matches criteria for one or more target nodes, and if so then retrieving an identifier associated with the one or more target nodes for which there is a criteria match; and logic instructions for determining whether the identifier associated with the one or more target nodes is in a PATH file associated with the data file, and if not then sharing the data file with the one or more target nodes.

### BRIEF DESCRIPTION OF THE DRAWINGS

The foregoing and other features, utilities and advantages of the invention will be apparent from the following more particular description of a preferred embodiment of the invention as illustrated in the accompanying drawings, in which

FIG. 1 is a schematic illustration of an exemplary enterprise network;

FIG. 2 is a schematic illustration of a system in accordance with the present invention;

FIGS. 3-6 are flowcharts illustrating a method for identifying properly formatted files;

FIG. 7 is a schematic illustration of a service network; and

FIGS. 8-9 are flowcharts illustrating a method of distributing service related data files.

### DETAILED DESCRIPTION

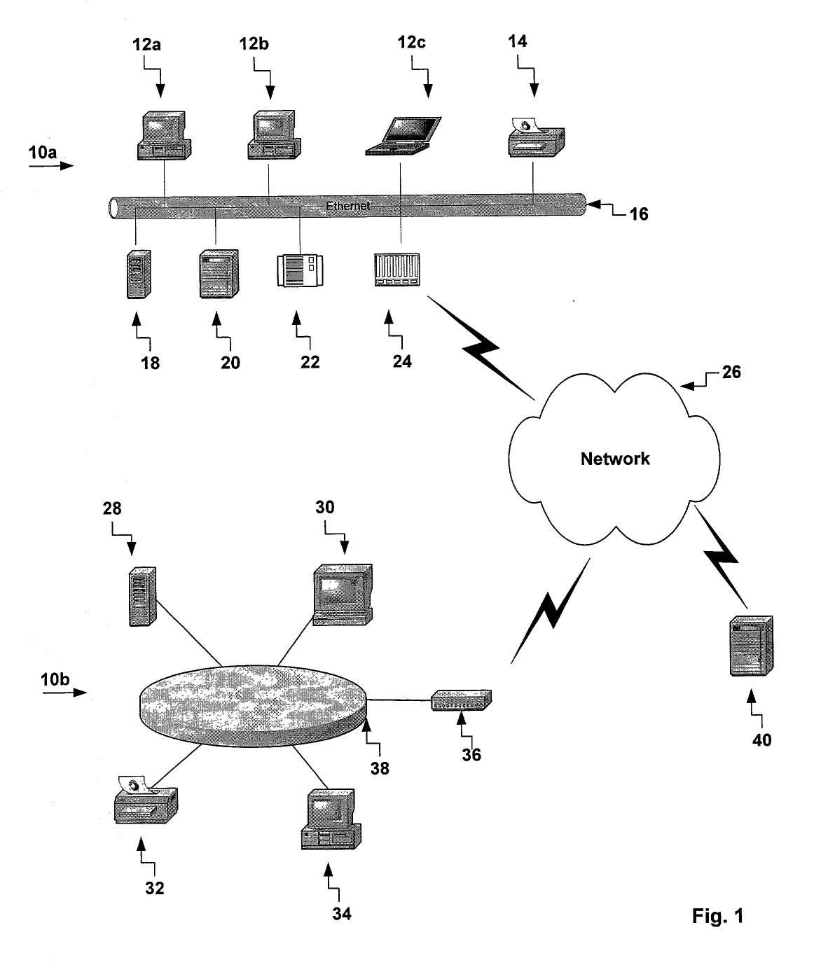

FIG. 1 is a schematic depiction of an exemplary enterprise network having a communication connection to a remote computer support service center. In a typical implementation, an enterprise network includes a plurality of independent networks (e.g., LANS, WANS, SANS) connected by a suitable communication network.

Referring to FIG. 1, an exemplary enterprise network has a first network cluster 10a including a plurality of personal computers 12a, 12b, 12c, printers, 14 or other computing devices connected by a suitable communication link 16. Network cluster 10a may also include one or more servers 18, minicomputers 20, and storage devices 22 connected to the communication link 16. A hub 24 provides a communication link between the first network cluster 10a and a broader communication network, exemplified by network cloud 26.

Enterprise network further includes a second network cluster 10b including a plurality of computing devices such as servers 28, workstations 30, printers 32, and personal computers 34 connected by a communication link 38. A hub 36 provides a communication link between the second network cluster 10b and a broader communication network, exemplified by network cloud 26.

It will be appreciated that the particular configuration of the various networks is not critical to the present invention. For example, the first network cluster may be connected by an ethernet LAN providing network connectivity to computers in a single building, a number of buildings, or across a corporate campus. Similarly, the second network cluster may be connected by a token ring network. The network cloud may be any suitable network, e.g., an X.25 network, an ATM network, or a TCP/IP network.

In one embodiment, the network operates in accordance with a client-server model, in which users of client computers make service requests from one or more server(s), and the server(s) provide the requested service. Servers may include (or be associated with) large capacity storage devices which can store copies of programs and data that can be retrieved by client computers over the communication link(s). By way of example, a user of one of the personal computers 12a, 12b, 12c may request a service from server 18. In response to this request, server 18 may access mass storage device 22 to retrieve necessary data, process the data, and return the results to the user at one of the personal computers 12a, 12b, 12c. By way of example, server 18 could provide e-mail service, storage service, printing service, or an application service. It will be appreciated that users at one of the personal computers 12a, 12b, 12c may make service requests from a server connected to a different network cluster. For example, a user at personal computer 12a may request a service from server 28.

FIG. 1 further illustrates a communication link between the enterprise network and a computer 40 that may be located in a network support service center. Information about computers serviced by the service center may be collected and transmitted to computer 40. This collection and transmittal may be done periodically, or may be otherwise initiated, e.g., by a computer user, a network administrator, a service support technician, or by a computer upon detection of a problem condition. Computer 40 receives, processes, and optionally stores this information, which may then be used to help diagnose network problems.

It will be appreciated that an enterprise network may include hundreds, or even thousands, of computer-based devices in multiple locations scattered across the globe. In addition, a network support service center may monitor multiple enterprise networks. Therefore, the computer(s) 40 in a network service center may receive a large number of files at a high data rate. As described above, the files may be in various formats. In one aspect, the present invention facilitates the efficient management of data processing in a network service center by providing a system and method for automatically recognizing properly formatted files. In an exemplary embodiment, the system implements a recursive algorithm to determine whether a received data file is in a format in which it can be recognized as a valid data file by the computer 40, or whether the file can be converted into a suitable format. If not, an error message may be generated and the file logged in a memory.

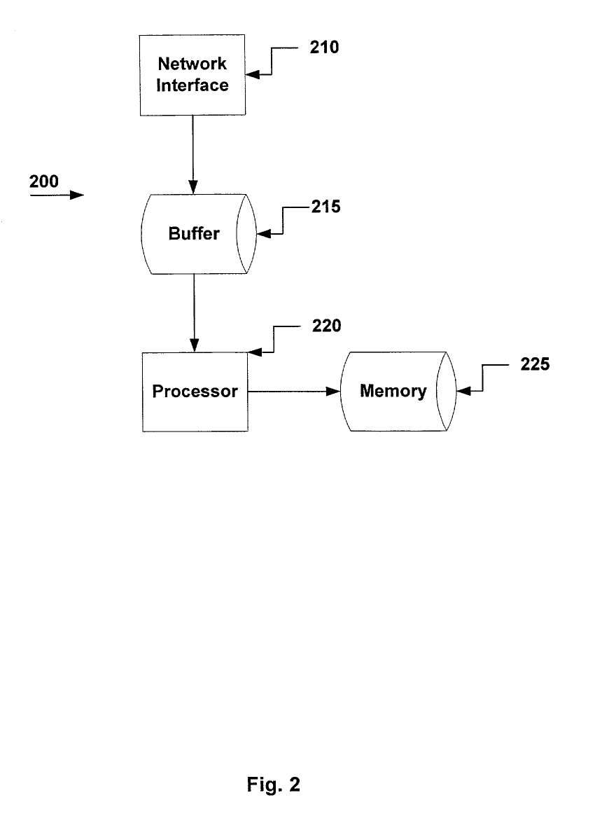

FIG. 2 is a functional block diagram of an exemplary file management system in accordance with one aspect of the present invention. Referring to FIG. 2, file management system 200 includes a network interface 210, an optional memory buffer 215, a processor 220, and a storage unit 225.

The network interface 210 connects to the communication link to the network, and, under the control of the processor 220, receives information from computers monitored by the network service center. The files may be stored temporarily as work units in a work list (or queue) in the optional memory buffer 215. The processor 220 retrieves work units from the optional memory buffer 215 and processes the files in accordance with logic instructions executable on the processor. After processing, files may be stored on storage unit 225.

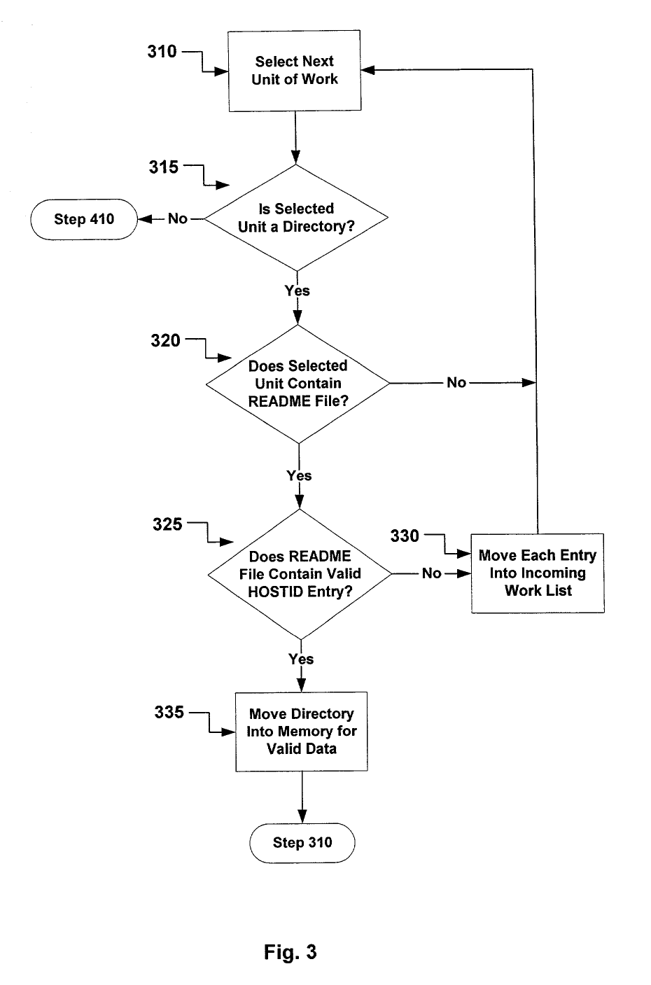

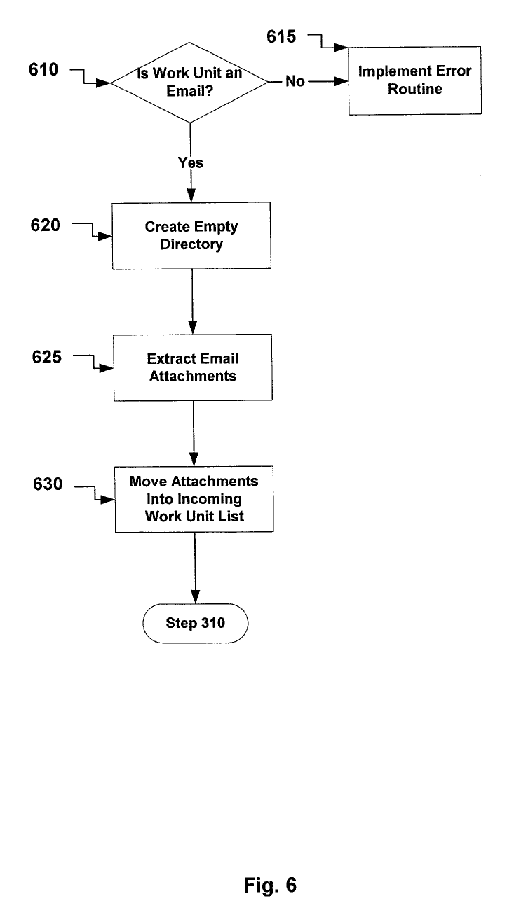

FIGS. 3-6 are flowcharts illustrating an exemplary method for determining whether a received file is in a format that can be recognized by a computer 40 in the network support service center. In the following description, it will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks.

These computer program instructions may also be stored in a computer-readable memory that can direct a computer or other programmable apparatus to function in a particular manner. The instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on other programmable apparatus to produce a computer implemented process such that the instructions which execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

As described above, selected computers in the network may have software installed that collects information about the computer. In an exemplary embodiment, the data collection software installed on monitored computers is configured to collect configuration data from the computer on which it is installed. The data collection software may also collect command outputs and/or copies of files from the computer on which it is installed. This information may be written to a file storable in computer memory. Subsequently, the file may be formatted, e.g., in a tar format, compressed, encoded, e.g., into ASCII, and e-mailed to the network service center.

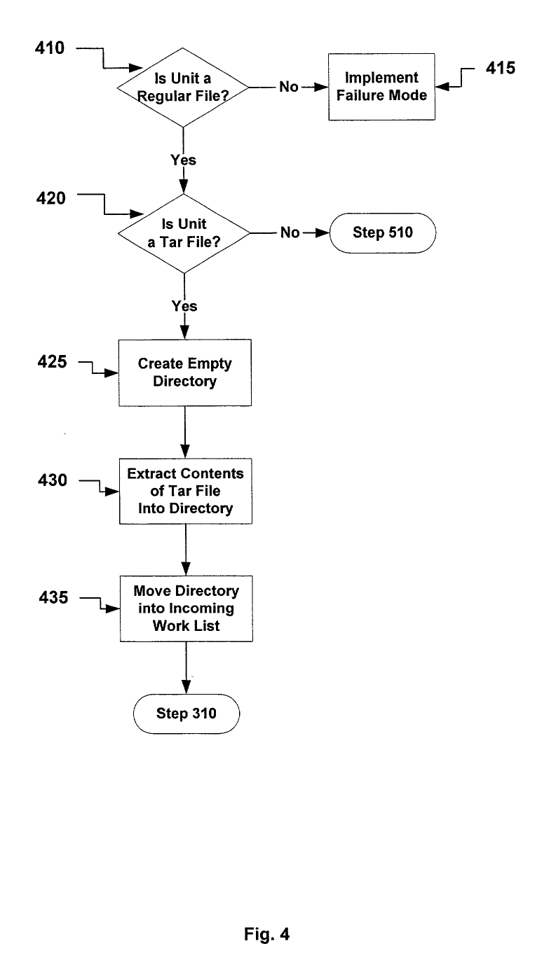

Referring to FIG. 3, the method begins at step 310, where the next work unit from the work list is selected for processing. At step 315, the system determines whether the retrieved work unit is a directory file. This may be accomplished by examining information associated with the work unit identifying the file type. If the work unit is not a directory, then control is passed to step 410 (see FIG. 4). If the work unit is a directory, then at step 320 it is determined whether the directory contains a README file, which may be accomplished by examining the contents of the directory to determine whether it includes a README file. If the directory does not include a README file, then the members of the directory are moved into the queue for incoming work. If the directory includes a README file, then at step 325 it is determined whether the README file includes a HOSTID entry in a valid format. In one embodiment of the invention, a valid HOSTID entry comprises an eight digit (hex) identifier. If the HOSTID entry is valid, then the directory is assumed to be valid and the information in the directory file is stored in a memory area reserved for valid data (step 330). If not, then the directory is moved back into the queue for incoming work units (step 335).

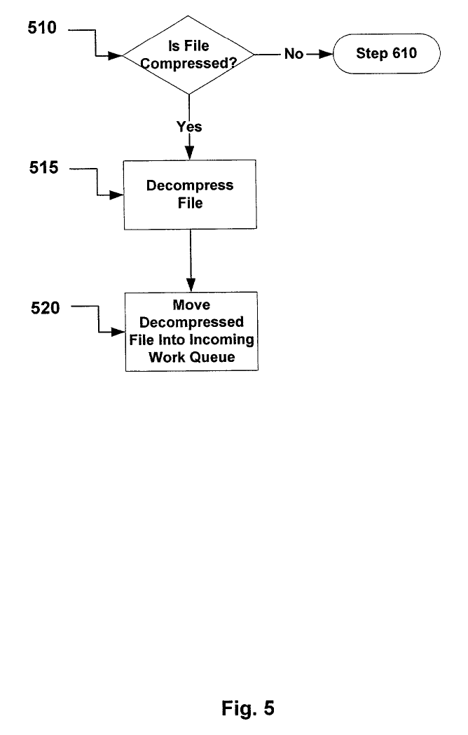

Referring to FIG. 4, at step 410 it is determined whether the work unit is a regular file, as opposed to a directory, a device, a symbolic link or another file-like entity. This may be determined by, e.g., executing a stat ( ) system call, which provides information about the file including the file type, modification time, size, etc. If the work unit is not a regular file, then an error routine is implemented (step 415) and the work unit is removed. The work unit may be stored in a memory log or simply discarded. By contrast, if the work unit is a regular file, then at step 420 it is determined whether the work unit is a tar file. This determination may be made by examining characters 257 through 261. If these characters are “ustar” then the file is a tar file. If the work unit is not a tar file, then control is passed to step 510 (see FIG. 5). If the work unit is a tar file, then at step 425 an empty directory is created, and at step 430 the contents of the tar file are extracted into the directory. At step 435 the directory is moved into the incoming work list, and control passes back to step 310.

Referring to step 5, at step 510 it is determined whether the work unit is a compressed file. This determination may be made by determining whether the first two bytes are octal 037 and 213, which is the convention used by gzip compression. If the work unit is not a compressed file, then control passes to step 610. By contrast, if the work unit is a compressed file, then at step 515 the work unit is decompressed. This may be accomplished by executing a decompression algorithm that performs the inverse functions of the compression algorithm used to compress the work unit. Commercially available compression and decompression software packages are suitable for use with the present invention. At step 520 the contents of the decompressed file are moved into the incoming work list, and control passes back to step 310.

Referring to step 610, it is determined whether the work unit is an e-mail. This determination may be made by examining the first five letters of the work unit. If the first five letters are “From”, then the work unit is treated as an e-mail. If the work unit is not an e-mail, then an error routine is invoked (step 615) and the work unit may be removed. The work unit may be stored in a memory log or discarded. By contrast, if the work unit is an e-mail, then at step 620 an empty directory is created and at step 625 the attachments to the e-mail are extracted and placed into the empty directory. At step 630 the directory of attachments are moved into the incoming work list, and control passes back to step 310.

The algorithm set forth in FIGS. 3-6 implements a recursive routine for identifying a received file to determine whether the file may include valid information about a serviced computer. As described above, in operation, software operating on a serviced computer generates configuration information (and, optionally, other information) about the serviced computer, places the information in a directory that includes a README file, tars the directory contents, compresses the tar file, and e-mails the compressed file to the service center. At the service center, the received e-mail may be placed in a list of work units for operation by a processor executing the logic instructions illustrated in FIGS. 3-6. At step 315, it will be determined that the work unit is not a directory, and control will be passed to step 410. At step 410 it will be determined that the work unit is a regular file, and at step 420 it will be determined that the work unit is not a tar file, and control will be passed to step 510. At step 510, it will be determined that the file is not a compressed file, and control will be passed to step 610. At step 610 it will be determined that the work unit is an e-mail and the e-mail attachments will be extracted and placed back into the queue of incoming work. In the next iteration, the e-mail attachments will be decompressed, and in the subsequent iteration, the decompressed files will be “untarred”, i.e., resulting in a directory that has a README file with a HOSTID entry. Accordingly, in the following iteration the logic instructions in FIG. 3 will cause the contents of the directory to be moved into a memory area for valid data. This data may then be processed in connection with service requests for the computer from which it was generated.

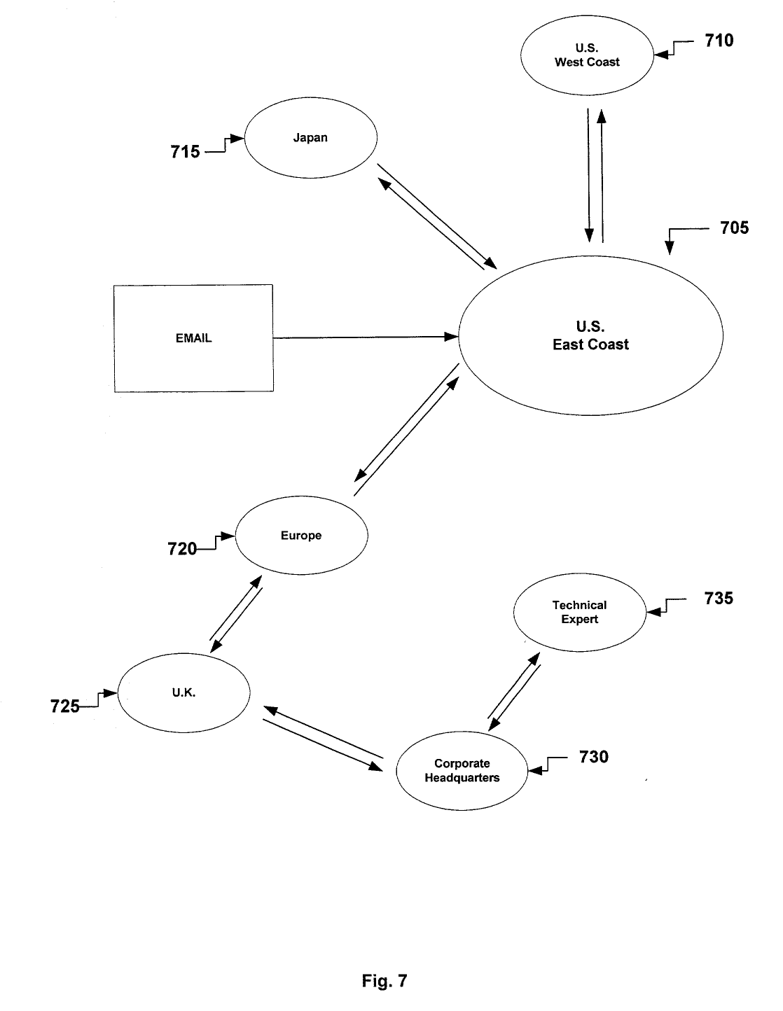

After a data file has been received and authenticated in a service support center, it may be necessary to distribute the data file to technical experts or other users of the support service. It will be appreciated that such technical experts may be distributed across the globe, and may be connected by a suitable computer network. By way of example, referring to FIG. 7, information about a particular computer(s) may be provided to a receiving node 705, e.g., by e-mail as described above. By way of example, the receiving node and the serviced computer may be on the U.S. East Coast. However, both the entity that owns the serviced computer and the service provider may have operations throughout the world. Accordingly, the receiving node 705 may be required to make the data file available to service nodes in North America 710, Japan 715, Europe 720, and the U.K. 725. In addition, the data file may need to be made available to a service node at the corporate headquarters 730 and to one or more specific technical experts 735. The receiving node 705 may have a direct communication link with a service node, such as the direct link between receiving node 705 and the service node in North America 710. Alternatively, communication links may be indirect, such as the link between the master node 705 and the service node 725 in the U.K., which is made through the service node in Europe 720.

In one embodiment, the system implements a hierarchical, push-driven distribution scheme, in which data files are selectively distributed (or mirrored) to users (or network nodes) based upon requests from the users. For example, network support personnel assigned to the nodes in North America 710, Japan 715, Europe 720, and at the corporate headquarters 730 may request that data files for the customer's computers be distributed from the receiving node 705 to their respective nodes. If the requests are approved, then the receiving node “pushes” a copy of the data file to the requesting node.

Similarly, network support personnel in the U.K. may request that data files for the customer's computers be distributed from the node in Europe 720 to the node in the U.K. 725. If this request is approved, then the node in Europe 720 “pushes” a copy of the data file to the node in the U.K. A particular technical expert 735 may request that data files for the customer's computers be distribute to the technical expert's node 735 from the node at the corporate HQ 730. In addition, it will be appreciated that users of the service node in the U.K. 725 and users of the service node at the corporate headquarters 730 may be able to request data files from one another.

In one aspect, the system generates an identifier that uniquely identifies servers. The identifier may be, e.g., a name assigned to a computer coupled with the computer's IP address. At step 815 the identifier is stored in a file that is readable via the network file system (NFS) protocol. This need only be performed once. This identifier is transmitted to the receiving node with information about the computer collected by the data collection software operation on the computer's processor.

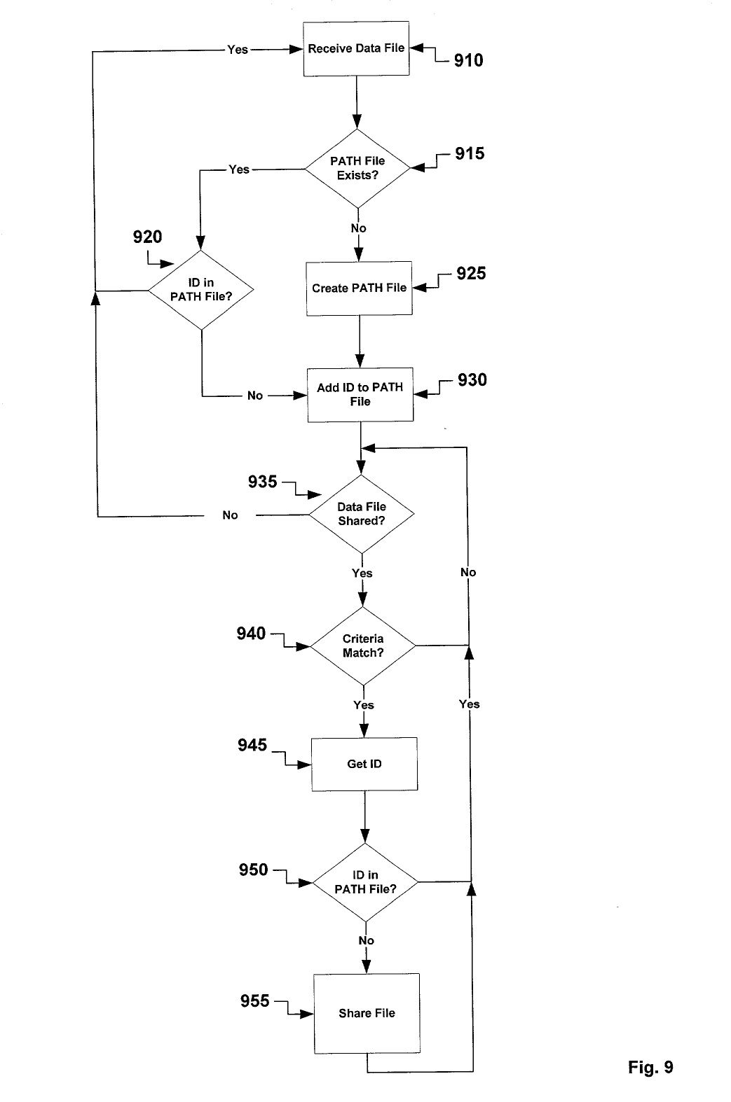

FIG. 9 is a flowchart illustrating an exemplary method of distributing data collected from computers in accordance with aspects of the present invention. Referring to FIG. 9, at step 910 the computer at the service node receives a data file from a computer being monitored by the service provider. Optionally, the data file may be authenticated using, e.g, the procedures set forth in FIGS. 3-6, above. At step 915 it is determined whether the data file includes a file named PATH. If the received data file does not include a PATH file, then at step 925 a path file is created and at step 930 an identifier associated with the computer at the service node is attached to the path file. By contrast, if the data file includes a file named PATH, then it is determined whether the identifier associated with the receiving service center is in the path file. If the identifier is in the PATH file, then control passes back to step 910, and the next incoming data file may be processed. If the identifier is not in the PATH file, then the identifier is added to the PATH file (step 930).

At step 935 it is determined whether the service node that received the data file is sharing the data file with one or more additional service nodes, which shall be referred to as “target” nodes. To accomplish this step, each service node may maintain a table that correlates the unique identifiers associated with computers being monitored with identifiers associated with target nodes in the service network. Alternatively, or in addition, the table may correlate customer information with identifiers associated with target nodes in the service network. Alternatively, or in addition, the table may correlate geographic information with target nodes in the service network. This table may be stored in a suitable memory location associated with the computer and accessed during processing. If the data file is not being shared with one or more target nodes in the service network, then control passes back to step 910, and the next incoming file is processed.

By contrast, if the data file is being shared with one or more target nodes in the service network, then steps 935 through 955 are repeated for each target node with which the information is shared. At step 940 it is determined whether the data file matches the criteria specified by a target node. For example, the target node may specify a geographic region, a country, a state, a city, an area code, a contract ID or a host ID. If the criteria are not satisfied, then control passes back to step 935 to determine whether there is another service center with which the information is being shared. By contrast, if the criteria are satisfied, then at step 945 an identifier associated with the target node is obtained. This identifier may be saved in a memory location associated with the receiving service node, or may be retrieved from the target node via a suitable communication link.

At step 950 it is determined whether the identifier associated with the target node is in the PATH file. If the identifier is in the PATH file, then control passes to step 935 to determine whether there is another target node with which the information is being shared. If the identifier associated with the service node with which information is being shared is not in the PATH file, then the data file is transmitted across a communication link to the target node, and control passes to step 935 to determine whether there is another target node with which the information is being shared. In one embodiment, the data file may be transmitted as an e-mail, e.g., in the same format in which the e-mail was transmitted from the monitored computer to the receiving node. Control then passes back to step 935 to determine whether there is another service center with which the information is being shared. When the list of target nodes is completed, control passes back to step 910 to process the next received file.

The logic instructions illustrated in FIG. 9 may be stored in suitable memory locations in computers in nodes of the service network. By way of example, assume a data file arrives at a receiving node 705 from a computer being monitored. The data file may be authenticated, e.g., using the procedures set forth in FIGS. 3-6. The receiving node 705 will create a PATH file and add its ID to the PATH file. The receiving node 705 will then consult a memory table to determine whether the data is to be shared with other nodes in the service network. In the exemplary configuration illustrated in FIG. 7, the memory table would reflect that the receiving node 705 shares the data with the four target nodes: the U.S. West Coast 710, Japan 715, Europe 720, and the corporate headquarters 730. Accordingly, steps 935 through 955 would be executed four times, once for each target node. Control would then return to step 910, and the receiving node 705 would process the next data file received.

When the data file is received in at the target nodes for the US. West Coast 710 and Japan 715, each of these nodes executes the logic instructions in FIG. 9. Each node would add its ID in the PATH file (step 930). Neither the U.S. West Coast 710 nor Japan 715 shares the data file with other nodes, so the logic instructions terminate at step 935, and control is passed back to step 910 to process the next received data file.

When the data file is received in the service node in Europe 720 and the service node at the corporate headquarters 730, each of these nodes would add its ID in the PATH file (step 930). When step 935 is executed in each of these nodes, their respective tables will reflect that the data file is shared with the node in the U.K. 725. Accordingly, the node in Europe 720 and the node at the corporate headquarters 730 will execute steps 940 through 955 and will transmit the data file to the node in the U.K. 725.

When the node in the U.K 725 receives the data file that arrives first in time, it will place its ID in the PATH file (step 930). When step 935 is executed, the table will indicate that the data file is shared with the node at the corporate headquarters 730. If the first-arrived data file is from the node at the corporate headquarters 730, then the test at step 950 will prevent the data file from being transmitted back to the node at the corporate headquarters 730. This precludes the possibility of an infinite loop of transmitting files between nodes 725 and 730. By contrast, if the first-arrived file is from the node in Europe, then the ID for the node at the corporate headquarters node 730 will not be in the path file, and the data file will be transmitted to the node at the corporate headquarters 730. This may result in redundant copies of the data file at the node at the corporate headquarters 730. Duplicate copies may be deleted. When the node at the corporate headquarters 730 executes the logic in FIG. 9, the test at step 950 will prevent the data file from being transmitted back to the node in the U.K. 725. The node in the corporate headquarters 730 also transmits the data file to the node for the technical expert 735 using the logic instructions set forth in FIG. 9.

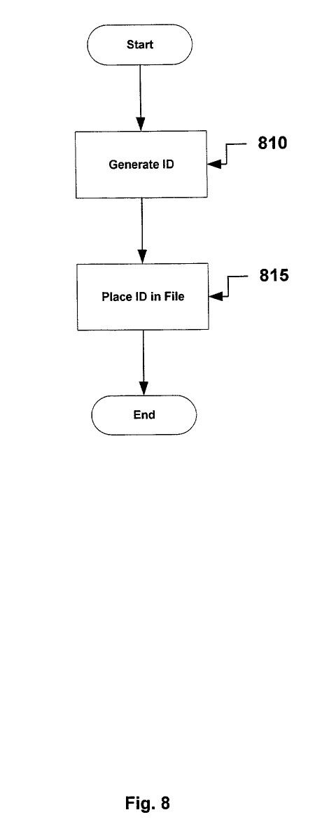

Thus, the logic instructions set forth in FIGS. 3-9 permit a service network to receive, authenticate, and distribute data files from computers monitored by the service network in an efficient manner.

While the invention has been particularly shown and described with reference to one or more exemplary embodiments thereof, it will be understood by those skilled in the art that various other changes in the form and details may be made without departing from the spirit and scope of the invention.

What is claimed is:

1. A method for distributing a data file received at a service center to selected nodes of a service network, comprising the steps of:
receiving a data file at a receiving node of a service network;
determining whether the data file is to be distributed to one or more target nodes in the service network;
determining whether the data file matches criteria for one or more target nodes, and if so then retrieving an identifier associated with the one or more target nodes for which there is a criteria match; and
determining whether the identifier associated with the one or more target nodes is in a PATH file associated with the data file, and if not then sharing the data file with the one or more target nodes.

2. The method of claim 1, further comprising the step of creating a PATH file if there is no path file associated with the data file.

3. The method of claim 1, wherein if an identifier associated with the receiving node of a service network is not in a PATH file associated with the received data file, then adding an identifier associated with the receiving node of the service network to the PATH file.

4. The method of claim 1, wherein the step of determining whether the data file is to be distributed to one or more target nodes in the service network includes searching a memory location in the receiving node for an identifier associated with one or more target nodes.

5. The method of claim 4, wherein the identifier comprises information identifying specific computers, customers, or geographic information.

6. The method of claim 1 wherein the step of sharing the data file with the target node comprises transmitting the data file over a communication link to the target node.

7. A service network comprising:
a plurality of service nodes, at least one of which is a receiving node for receiving data files from computers being monitored by the service network; and
a processor associated with the receiving node for determining whether a received data file is to be distributed to one or more target nodes in the service network, determining whether the data file matches criteria for one or more target nodes, and if so then retrieving an identifier associated with the one or more target nodes for which there is a criteria match, and determining whether the identifier associated with the one or more target nodes is in a PATH file associated with the data file, and if not then sharing the data file with the one or more target nodes.

8. The service network of claim 7, wherein the processor creates a PATH file if there is no path file associated with the data file.

9. The service network of claim 7, wherein the processor determines if an identifier associated with the receiving node of a service network is in a PATH file associated with the received data file, and if not then adds an identifier associated with the receiving node of the service network to the PATH file.

10. The service network of claim 7, wherein the processor searches a memory location in the receiving node for an identifier associated with one or more target nodes.

11. The service network of claim 10, wherein the identifier comprises information identifying specific computers, customers, or geographic information.

12. The service network of claim 7, wherein the processor transmits the data file over a communication link to the target node.

13. A computer program product for use in connection with a computer for processing data files received at a receiving node of a service network and distributing data files to selected nodes of a service network, comprising:
logic instructions for receiving a data file at a receiving node of a service network; and
logic instructions for determining whether the data file is to be distributed to one or more target nodes in the service network
logic instructions for determining whether the data file matches criteria for one or more target nodes, and if so then retrieving an identifier associated with the one or more target nodes for which there is a criteria match; and
logic instructions for determining whether the identifier associated with the one or more target nodes is in a PATH file associated with the data file, and if not then sharing the data file with the one or more target nodes.

14. The computer program product of claim 13, further comprising logic instructions for creating a PATH file if there is no path file associated with the data file.

15. The computer program product of claim 13, further comprising logic instructions for determining if an identifier associated with the receiving node of a service network is in a PATH file associated with the received data file, and if not then adding an identifier associated with the receiving node of the service network to the PATH file.

16. The computer program product of claim 13, wherein the logic instructions for determining whether the data file is to be distributed to one or more target nodes in the service network include instructions for searching a memory location in the receiving node for an identifier associated with one or more target nodes.

17. The computer program product of claim 16, wherein the identifier comprises information identifying specific computers, customers, or geographic information.

18. The computer program product of claim 13, wherein logic instructions for performing the step of sharing the data file with the target node comprise instructions for transmitting the data file over a communication link to the target node.
